(19) United States
(12) Patent Application Publication
(10) Pub. No.: US 2003/0158779 A1
(43) Pub. Date: Aug. 21, 2003

(54) Electronic advertisement browse promoting system, electronic advertisement browse promoting device, electronic advertisement browse promoting device built-in type computer, and electronic advertisement browse promoting method

(75) Inventor: Kazutaka Kochi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/260,617

(22) Filed: Oct. 1, 2002

(30) Foreign Application Priority Data
Feb. 18, 2002 (JP) 2002-40358

(51) Int. Cl. G06F 17/60

(52) U.S. Cl. 705/14

(57) ABSTRACT

An electronic advertisement browse promoting system for promoting browse of an electronic advertisement, includes a server distributing electronic advertisement information via a network, an acquisition unit acquiring the electronic advertisement information distributed from the server, a storage unit storing the electronic advertisement information acquired by the acquisition unit and thereafter storing information indicating a user's response to the stored electronic advertisement information, and a transmitting unit transmitting to a predetermined terminal the information indicating the user's response that has been stored in the storage unit.

### BACKGROUND OF THE INVENTION

The present invention relates to an electronic advertisement browse promoting system, an electronic advertisement browse promoting device, a computer including a computer main unit incorporating the above device, a method thereof and a program.

An electronic advertisement has hitherto been often displayed as a part of a content provided from a Web site on the Internet or displayed at a beginning or an end of an E-mail text.

The electronic advertisement is attached to substantial and objective information and is therefore conceived auxiliary, a direct monetary profit can not be acquired even by browsing the advertisement, and a response declines and communication costs increases due to downloading of the advertisement. For these reason, there arises a problem in which it is difficult to motivate a positive browse of the electronic advertisement.

It is a primary object of the present invention to motivate the positive browse of the electronic advertisement.

### SUMMARY OF THE INVENTION

To accomplish the above object, according to one aspect of the present invention, an electronic advertisement browse promoting system for promoting browse of an electronic advertisement, includes a server distributing electronic advertisement information via a network, an acquisition unit acquiring the electronic advertisement information distributed from the server, a storage unit storing the electronic advertisement information acquired by the acquisition unit and thereafter storing information indicating a user's response to the stored electronic advertisement information, and a transmitting unit transmitting to a predetermined terminal the information indicating the user's response that has been stored in the storage unit.

According to the present invention, the information indicating the user's response to the electronic advertisement information is transmitted to the predetermined terminal (including the server). Then, it is judged in a transmitting destination whether the advertisement is browsed as the initial contract specifies. As a result, when judging that the advertisement is not browsed in the way specified by the initial contract, a user may be warned to keep the contract. Namely, the advertisement browsing by the user can be promoted by warning the user to browse the advertisement as the initial contract specifies.

The electronic advertisement browse promoting system may further include, for instance, an electronic advertisement output unit outputting an electronic advertisement based on the electronic advertisement information stored in the storage unit.

The electronic advertisement browse promoting system may further include, for example, a computer main unit including the acquisition unit, the storage unit and the transmitting unit as built-in components.

In the electronic advertisement browse promoting system, for instance, the electronic advertisement output unit may be built in the computer main unit.

The electronic advertisement browse promoting system may further include, for example, a first judging unit judging, based on the information indicating the user's response that has been storage unit and information indicating a predetermined first condition that should be kept by the user with respect to the electronic advertisement information, whether the first condition is met, wherein if the first judging unit judges that the first condition is not met, an indication for prompting the user to meet the first condition may be outputted to the electronic advertisement output unit.

With this contrivance, for example, the first condition is set so that ten pieces of advertisement shall be read with the predetermined period. If the number of advertisements browsed within this period is less than 10, the indication for prompting the user to browse more advertisements may be given to the user.

In the electronic advertisement browse promoting system, the information indicating the user's response may be, e.g., information indicating a present unread count with respect to the electronic advertisement information stored in the storage unit, and the first condition may be a first total count of pieces of electronic advertisement information that should be browsed by the user within a predetermined period. The first condition may be preset in the contract.

The electronic advertisement browse promoting system may further include a second judging unit judging, based on the information indicating the user's response that has been storage unit and information indicating a predetermined second condition that should be kept by the user with respect to the electronic advertisement information, whether the second condition is met, and a control unit controlling the computer main unit if the second judging unit judges that the second condition is not met.

With this contrivance, for example, the second condition is set so that twenty pieces of advertisements shall be read within the predetermined period. If the number of the advertisement browsed within this period is smaller than 20, the computer main unit can be controlled. What can be thought of as a control mode is that the computer main unit can not be used for purposes other than browsing the advertisement.

In the electronic advertisement browse promoting system, the second condition may be, for example, a second total count of pieces of electronic advertisement information that should be browsed by the user with the predetermined period.

In the electronic advertisement browse promoting system, for instance, the second total count may be set larger than the first total count. With this contrivance, the computer main unit can be controlled stepwise. Namely, the scheme is not that the computer main unit is controlled straight so as to be unusable but that the indication for prompting the user to browse the advertisement can be displayed beforehand.

In the electronic advertisement browse promoting system, for example, the first judging unit, the second judging unit and the control unit may be built in the computer main unit.

In the electronic advertisement browse promoting system, for instance, the first and second judging units may be provided on the predetermined terminal, the control unit may be built in the computer main unit, and the computer main unit may further include a judgement result acquisition unit acquiring results of the judgements made by the first and second judging units from on the predetermined terminal.

In the electronic advertisement browse promoting system, the control unit may, when judging that the second condition is not met, control the computer main unit not to accept operations other than the user's operation for displaying the electronic advertisement on the electronic advertisement output unit. With this contrivance, the motivation for browsing the electronic advertisement can be enhanced.

In the electronic advertisement browse promoting system, the control unit may, when judging that the second condition is met, control the computer main unit to accept the operations other than the user's operation for displaying the electronic advertisement on the electronic advertisement output unit.

According to another aspect of the present invention, an electronic advertisement browse promoting device for promoting browse of an electronic advertisement, includes an acquisition unit acquiring electronic advertisement information, a storage unit storing the electronic advertisement information acquired by the acquisition unit and thereafter storing information indicating a user's response to the stored electronic advertisement information, and a transmitting unit transmitting to a predetermined terminal the information indicating the user's response that has been stored in the storage unit.

According to still another aspect of the present invention, an electronic advertisement browse promoting device built-in type computer including a computer main unit having a built-in electronic advertisement browse promoting device for promoting browse of an electronic advertisement, includes an acquisition unit acquiring the electronic advertisement information, a storage unit storing the electronic advertisement information acquired by the acquisition unit and thereafter storing information indicating a user's response to the stored electronic advertisement information, and a transmitting unit transmitting to a predetermined terminal the information indicating the user's response that has been stored in the storage unit.

According to a further aspect of the present invention, an electronic advertisement browse promoting method in a computer including a computer main unit having, as built-in components, an acquisition unit acquiring the electronic advertisement information, a storage unit storing the acquired electronic advertisement information and an electronic advertisement output unit displaying an electronic advertisement based on the stored electronic advertisement information, the method including storing information indicating a user's response to the stored electronic advertisement information, and transmitting to a predetermined terminal the stored information indicating the user's response.

According to a still further aspect of the present invention, an electronic advertisement browse promoting program in a computer including a computer main unit having, as built-in components, an acquisition unit acquiring the electronic advertisement information, a storage unit storing the acquired electronic advertisement information and an electronic advertisement display unit displaying an electronic advertisement based on the stored electronic advertisement information, the program making the computer execute storing information indicating a user's response to the stored electronic advertisement information, and transmitting to a predetermined terminal the stored information indicating the user's response.

### BRIEF DESCRIPTION OF THE DRAWINGS

FIG. 1 is an explanatory diagram showing an outline of a system architecture of a system for promoting a browse of an electronic advertisement according to the present invention;

FIG. 2 is an explanatory view illustrating an external configuration of an information terminal included in the electronic advertisement browse promoting system according to the present invention;

FIG. 3 is an explanatory diagram illustrating mainly a hardware architecture of the information terminal included in the electronic advertisement browse promoting system of the present invention;

FIG. 4 is a diagram showing an example of advertisement data stored in a storage unit of the information terminal included in the electronic advertisement browse promoting system of the present invention;

FIG. 5 is a diagram showing an example of individual data stored in the storage unit of the information terminal included in the electronic advertisement browse promoting system of the present invention;

FIG. 6 is an explanatory diagram illustrating mainly a hardware architecture of a server included in the electronic advertisement browse promoting system of the present invention;

FIG. 7 is a diagram showing an example of advertisement data stored in a storage unit of the server included in the electronic advertisement browse promoting system of the present invention;

FIG. 8 is a diagram showing an example of the advertisement data stored in the storage unit of the server included in the electronic advertisement browse promoting system of the present invention;

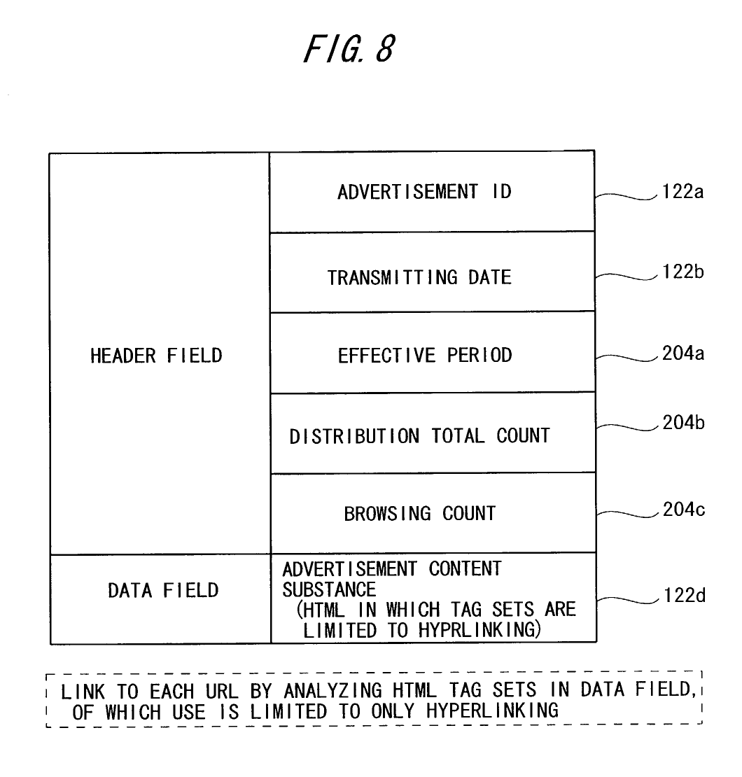

FIG. 9 is an explanatory flowchart showing an operation of the electronic advertisement browse promoting system of the present invention;

FIG. 10 is an explanatory flowchart showing an advertisement distribution request process in the electronic advertisement browse promoting system of the present invention;

FIG. 11 is an explanatory flowchart showing an advertisement browse management process in the electronic advertisement browse promoting system of the present invention;

FIG. 12 is a diagram showing a display example of an indication for prompting a browse of the advertisement on the information terminal included in the electronic advertisement browse promoting system of the present invention;

FIG. 13 is an explanatory flowchart showing an electronic advertisement display process in the electronic advertisement browse promoting system of the present invention; and

FIG. 14 is an explanatory flowchart showing an operation of the electronic advertisement browse promoting system of the present invention.

### DETAILED DESCRIPTION OF THE PREFERRED EMBODIMENT

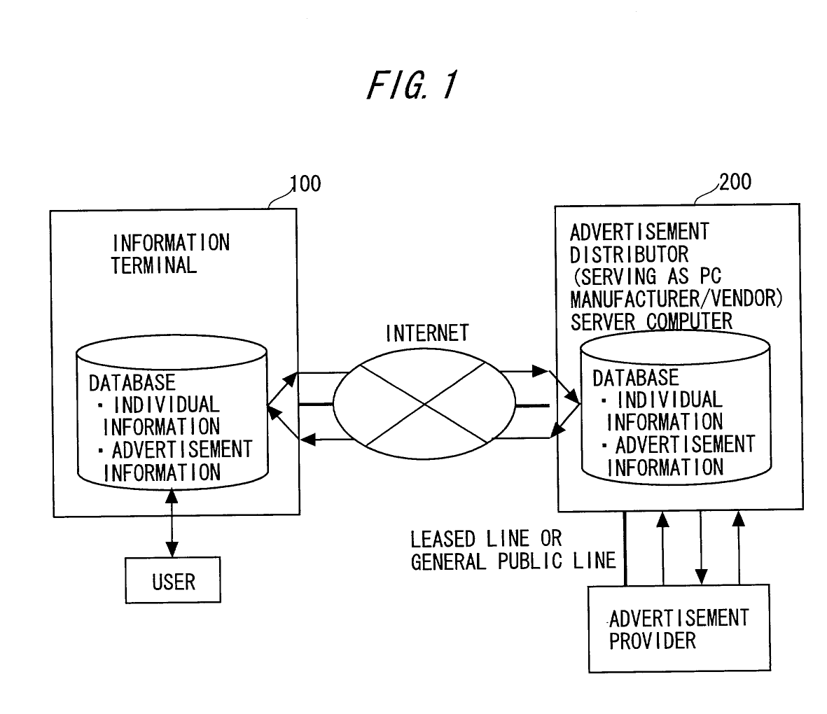

An outline of a system architecture of a system for promoting browse of an electronic advertisement according to the present invention, will hereinafter be described with reference to the accompanying drawings. FIG. 1 is an explanatory diagram showing the outline of the system architecture of the electronic advertisement browse promoting system.

As shown in FIG. 1, the electronic advertisement browse promoting system includes an information terminal 100 and a server 200 for distributing predetermined categories of electronic advertisement information via a network such as the Internet. The information terminal 100 and server 200 can perform data communications with each other via the network.

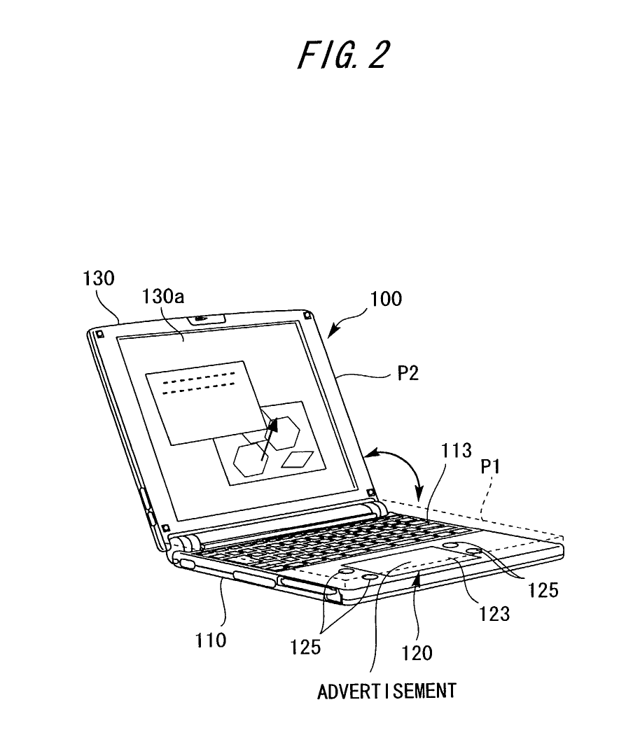

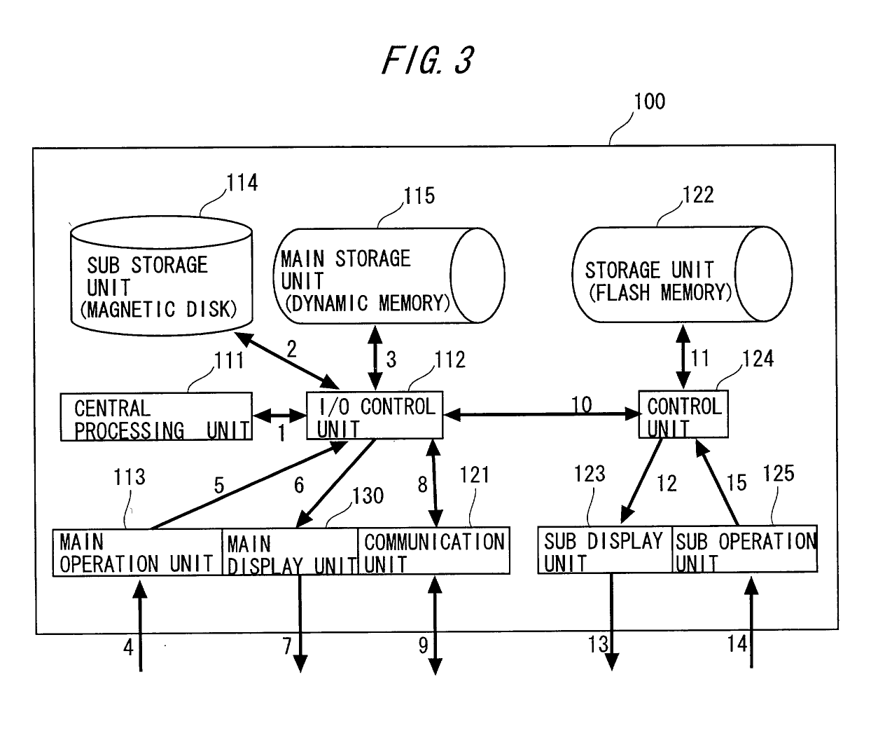

To start with, a configuration of the information terminal 100 will be explained referring to FIGS. 2 and 3. FIG. 2 is an explanatory view illustrating an external configuration of the information terminal included in the electronic advertisement browse promoting system. FIG. 3 is an explanatory diagram illustrating mainly a hardware architecture of the information terminal included in the electronic advertisement browse promoting system.

As shown in FIG. 2, the information terminal 100 is classified as a foldable notebook size personal computer. The information terminal 100 has a computer main unit 110, an electronic advertisement browse promoting device 120 and an image display unit 130.

As depicted in FIG. 3, the computer main unit 110 includes a CPU 111 that controls operations of the whole system. An I/O control unit 112, a main operation unit 113, a sub storage unit 114, a main storage unit (dynamic memory) 115 are connected via a bus etc to the CPU 111. Further, a communication unit 121, a storage unit (flash memory) 122, a sub display unit 123, a control unit 124 and a sub operation unit 125 are connected via the bus etc to the CPU 111.

The electronic advertisement browse promoting device 120 is constructed of the components designated by the numerals 121 through 125. Further, the main display unit 130 is connected via the bus etc to the CPU 111.

The I/O control unit 112 is a device for controlling inputs and outputs between the individual components built in the information terminal 100. The main operation unit 113 is a device for inputting to the computer main unit 110 various items of information and commands given from a user. The main operation unit 113 is the input device such as a keyboard, a mouse and so on.

The sub storage unit 114 is a storage device such as a hard disk device and others. A predetermined operating system (which will hereinafter be abbreviated to OS) such as Windows, MacOS, UNIX etc is preinstalled into the sub storage unit 114. A predetermined program such as an application and Browser running on the OS is further preinstalled into the sub storage unit 114. The main storage unit 115 is a memory such as DRAM (Dynamic Random Access Memory).

The electronic advertisement browse promoting device 120 includes the communication unit 121, a storage unit 122, the sub display unit 123, the control unit 124 and the sub operation unit 125.

The communication unit 121 is a device for performing the data communications with the server 200 and other predetermined terminals via the network. The communication unit 121, for example, obtains electronic advertisement information from the server 200 via the network, and transmits to the server 200 pieces of data (which are, e.g., information containing a browse state flag 122c defined as information indicating a response of the user that will be explained later on) stored in the storage unit 122. The communication unit 121 involves the use of a device (such as a modem, a TA (Terminal Adapter), a router and so on) suited to the network.

The storage unit 122 is a storage device such as a flash memory, a hard disk device and others. The storage unit 122 is stored with advertisement data containing an advertisement content substance 122d defined as the electronic advertisement information obtained from the server 200 through the communication unit 121. The advertisement data consists of an advertisement ID 122a, a transmission date 122b, the browse state flag 122c, the advertisement content substance 122d and link information 122e.

The advertisement ID 122a is a piece of information for identifying the advertisement content substance 122d. The transmission date 122b is defined as a piece of information for specifying a date and time when the advertisement content substance 122d has been distributed. The browse state flag 122c is a piece of information indicating a user's response to the advertisement content substance 122d stored in the storage unit 122. What is exemplified as the browse state flag 122c may be, for instance, information (flag) indicating which option, “already read”, “not yet read” and “discard”, is taken with respect to the advertisement content substance 122d stored therein.

The advertisement content substance 122d defined as the electronic advertisement information is the advertisement content itself, and is what the advertisement content is described in, e.g., a text data format, an XML format and otherwise.

The link information 122e is a URL (Uniform Resource Locator) etc of a homepage linked to the advertisement content substance 122d. the link information 122e is specified (clicked) for displaying, when the advertisement content (E-advertisement) based on the advertisement content substance 122 is displayed on the sub display unit 123, a homepage linked thereto on the Browser. Note that if an advertisement content substance 204f is described in HTML wherein the use of tag sets is limited to only hyperlinking, the homepage can be displayed without using the link information 122e.

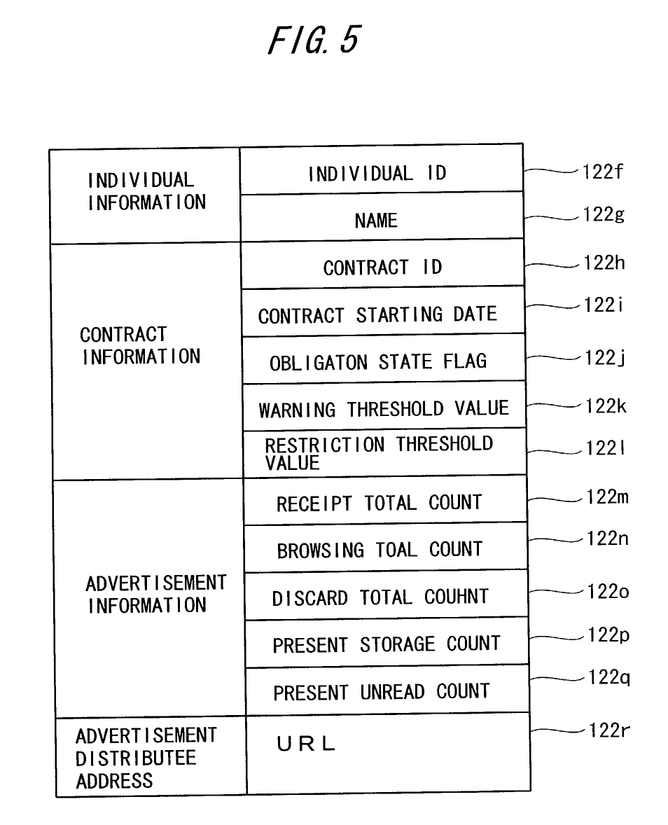

Further, the storage unit 122 is stored with individual data containing, as shown in FIG. 5, individual information, contract information, advertisement information and an advertisement distributee address.

The individual information is used for specifying the user and consists of an individual ID 122f and a name 122g.

The contract information consists of a contract ID 122h, a contract starting date 122i, an obligation state flag 122j, a warning threshold value 122k and a restriction threshold value 122l. The obligation state flag 122j is a piece of information indicating the number of advertisement content substances that should be browsed by the user as an obligation (in terms of the contract) within a predetermined period of time (e.g., half a year).

The warning threshold value 122k is information indicating a first condition that should be kept by the user about the advertisement content substances 122a. The first condition is a total number (a first total count) of the advertisement content substances that should be browsed by the user as an obligation within a predetermined period of time (e.g., one week).

The restriction threshold value 122l is information indicating a second condition that should be kept by the user about the advertisement content substances 122a. The second condition is a total number (a second total count) of the advertisement content substances that should be browsed by the user as an obligation within a predetermined period of time (e.g., one week). According to this embodiment, the first and second total counts are preset such as: the second total count>the first total count. This setting schemes to execute stepwise control.

The advertisement information consists of a receipt total count 122m, a browsing total count 122n, a discard total count 122o, a present storage count 122p and a present unread count 122q. The receipt total count 122m is a piece of information indicating a total number of the advertisement content substances 122a obtained from the server 200.

The browsing total count 122n is information indicating a total number of the advertisement content substances 122a browsed by the user among those stored in the storage unit 122. The discard total count 122o is information indicating a total number of the advertisement content substances 122a discarded by the user among those stored in the storage unit 122.

The present storage count 122p is information indicating a total number of the advertisement content substances 122a stored at the present time in the storage unit 122. The present unread count 122q is information indicating a total number of the advertisement content substances 122a not browsed by the user among those stored at the present time in the storage unit 122. The browsing total count 122n, the discard total count 122o and the present unread count 122q correspond to pieces of information representing the user's responses with respect to the E-advertisement information stored in the storage unit 122.

The advertisement distributee address 122r is information indicating an on-the-network address of a distributee to whom the advertisement is distributed. According to this embodiment, the advertisement distributee address 122r is a URL or an IP (Internet Protocol) address of the server 200. The advertisement distributee address is used for accessing the server 200 in order to obtain the advertisement content substance etc.

The sub display unit 123 is a device for displaying an advertisement content (E-advertisement) on the basis of the advertisement content substance 122d stored in the storage unit 122. The sub display unit 123 corresponds to an electronic advertisement output unit. The sub display unit 123 is classified as an image display device such as a CRT display, a liquid crystal display and so on. Further, the sub display unit 123 may involve the use of a printing device such as a printer, wherein the advertisement content (E-advertisement) can be printed out by this printing device.

The sub display unit 123 is, as shown in FIG. 2, provided at, for example, the central area, on the front side (distal end) of the computer, of the upper surface of the computer main unit 110. The sub display unit 123 may be provided outside the computer main unit 110 and be connected to the computer main unit 110 via a cable. Note that FIG. 2 shows an example in which the sub display unit 123 is built in the computer main unit 110.

The control unit 124 is a device for controlling the computer main unit 110, the storage unit 122, the sub display unit 123 and the sub operation unit 125.

The sub operation unit 125 is a device for inputting, to the E-advertisement browse promoting device 120, various pieces of information and commands (such as a command for displaying the advertisement, a command for discarding the advertisement content substance, information for specifying a discard target advertisement and others) given from the user. The sub operation unit 125 is, e.g., a button type input device. FIG. 2 shows an example of a layout of elements (buttons) of the sub operation unit 125. Further, the sub operation unit 125 may involve the use of the input device such as the keyboard, the mouse, etc.

The main display unit 130 is a device for displaying a variety of images as on the home page. The main display unit 130 is classified as an image display device such as the CRT display, the liquid crystal display and others. The main display unit 130 is, as illustrated in FIG. 2, pivotally secured to the computer main unit 110. Therefore, the main display unit 130 can be, when unused, folded by pivotally moving the main display unit 130 from a normal use position P2 down to a folding position P1 depicted by a dotted line in FIG. 2. A display screen 130a is provided on the front surface of the main display unit 130.

A rear surface of the main display unit 130 may also be provided with the sub display unit 123 and the sub operation unit 125. If thus configured, even in the folded state of the main display unit 130, a display content (the advertisement etc) on the sub display unit 123 can be browsed, and an operation corresponding to the display content can be done.

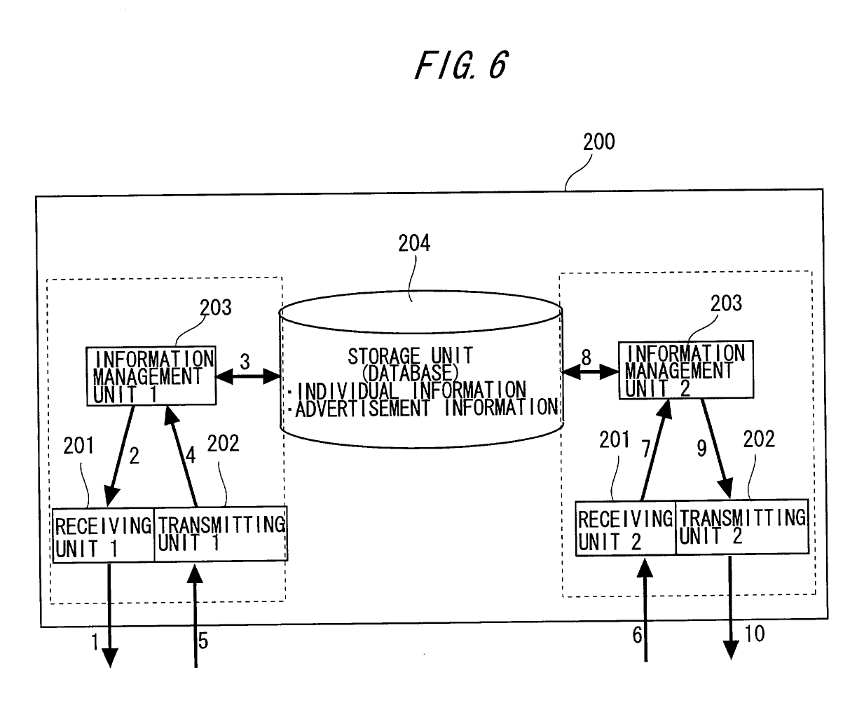

Next, an architecture of the server 200 will be explained referring to FIG. 6. FIG. 6 mainly illustrates a hardware architecture of the server 200.

As shown in FIG. 6, the server 200, which involves the use of a comparatively high performance computer like a workstation, includes a receiving unit 201, a transmitting unit 202, an information management unit 203 and a storage unit 204. The server 200 has an unillustrated CPU to which the receiving unit 201, the transmitting unit 202, the information management unit 203 and the storage unit 204 are connected via a bus.

The receiving unit 201 and the transmitting unit 202 are devices for performing the data communications with the information terminal 100 via the network. The receiving unit 201 obtains from the information terminal 100, for instance, the information indicating the user's response that is stored in the storage unit 122 thereof. The transmitting unit 202 transmits to the information terminal 100, for example, the individual data (see FIG. 5) containing the advertisement content substance 122d stored in the storage unit 204.

The information management unit 203 writes to the storage unit 204 the information (e.g., the information indicating the user's response) obtained from the information terminal 100 via the receiving unit 201. Further, the information management unit 203 reads the information (e.g., the advertisement content substance) from the storage unit 204. The readout information is transmitted to the information terminal 100 via the transmitting unit 201. The information management unit 203 is, for instance, a DBMS (DataBase Management System). Note that another suite of the receiving unit 201, the transmitting unit 202 and the information management unit 203 are provided for load sharing of the server 200 in this embodiment.

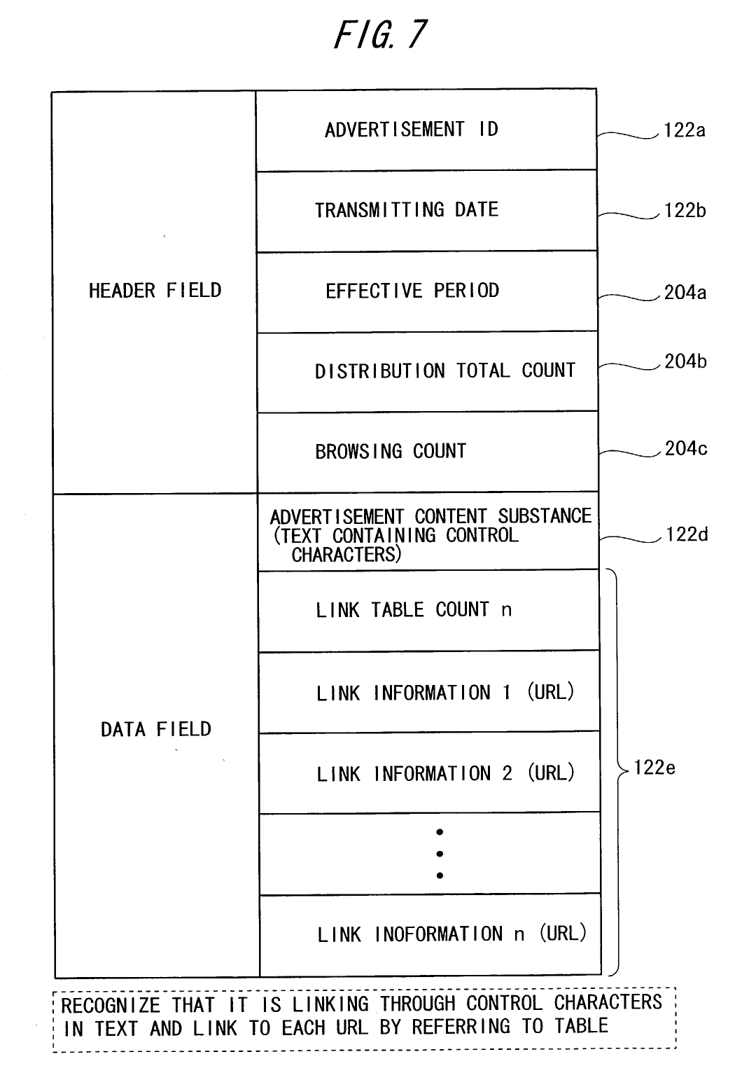

The storage unit 204 is a storage device such as a hard disk device and so on, and a database is configured on this storage device. The storage unit 204 (database) is stored with, as illustrated in FIG. 7, the advertisement data containing the advertisement content substance 204f defined as the E-advertisement information distributed to the information terminal 100 .

The advertisement data consists of an advertisement ID 122a, a transmission date 122b, an effective period 204a, a distribution total count 204b, a browsing count 204c, an advertisement content substance 122d and link information 122e.

The effective period 204a is a piece of information indicating a set period for which the distribution of the advertisement content substance 122d has a validity. The distribution total count 204b is information representing a total number of times with which the advertisement content substance 122d identified by the advertisement ID 122a is distributed to the information terminal 100. The browsing count 204c is information indicating a total number of times with which the advertisement content substance 122d identified by the advertisement ID 122a has already been read.

Further, the storage unit 204 (database) is stored with the individual data (see FIG. 5) stored in the storage unit 122 of the information terminal 100.

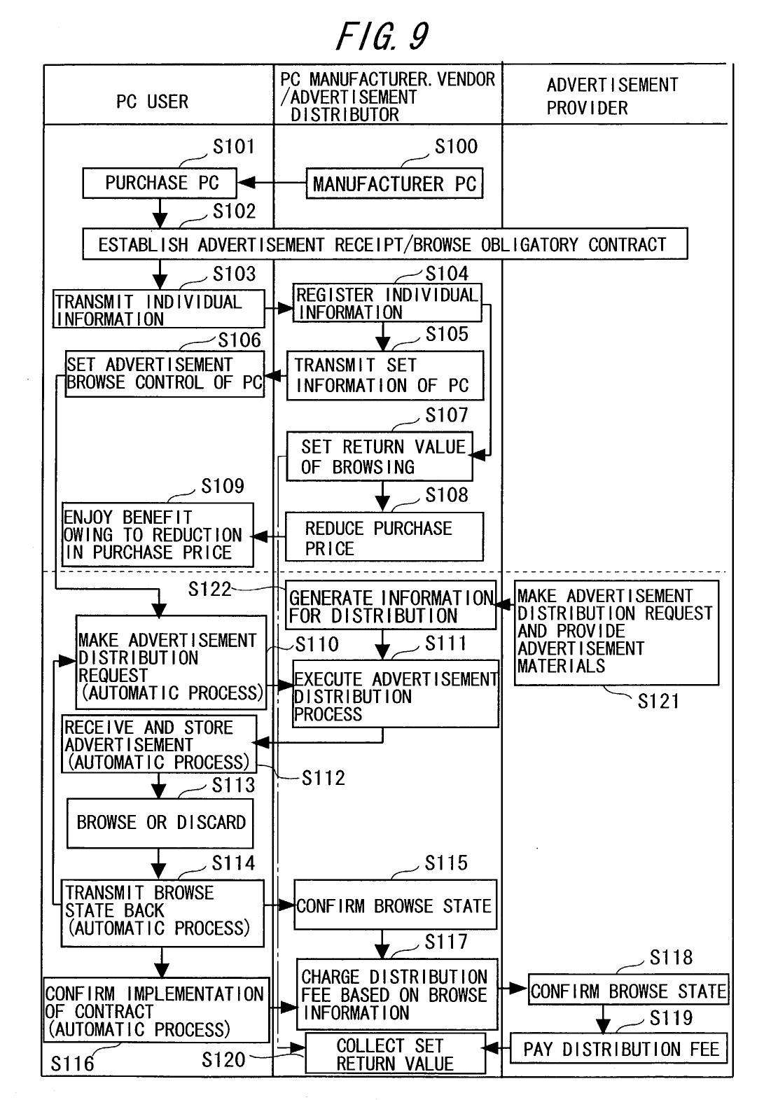

Next, an operation of the E-advertisement browse promoting system having the architecture described above, will be explained with reference to the drawings. FIG. 9 is an explanatory flowchart showing the operation of the E-advertisement browse promoting system. Chiefly the CPU 111 and the control unit 124 execute predetermined programs, thereby actualizing the following processes.

In the discussion that follows, a PC manufacturer vendor/advertisement distributor will hereinafter be simply called an “PC-based ad (advertisement) entrepreneur”, or a much simpler name of “entrepreneur” might be used. The PC-based ad entrepreneur is defined as a manufacturer and a vendor of the information terminal 100 and also an administrator of the server 200. A PC user will hereinafter be simply called a user. The user purchases the information terminal 100 from the entrepreneur and utilizes the terminal 100. An advertisement provider is defined as a party that uploads the data containing the advertisement content substance as advertisement data from a predetermined terminal to the server 200.

When the user purchases the information terminal 100 from the entrepreneur (S100, S101), an advertisement receipt/browse obligatory contract is agreed upon between the user, the entrepreneur and the advertisement provider (S102). The advertisement receipt/browse obligatory contract is defined as a contract settled about receiving the E-advertisement via the Internet and implementing a predetermined quantity of E-advertisement browsing obligation. The user enjoys a benefit such as a reduction in the purchase price of the information terminal 100 as a return value of making the contract.

The user, when establishing the contract, inputs and transmits the individual self-information from the purchased information terminal 100 to the server 200 (S103). The server 200, upon receiving the individual information through the receiving unit 201, generates the individual data (see FIG. 5), and indicates the information management unit 203 to register the individual data in the storage unit 204 (database) (S104).

Further, the server 200 transmits to the information terminal 100 the thus generated individual data as set information (S105). The information terminal 100 receives the set information and stores (sets) the same information in the storage unit 122 (S106). Further, a return value of the browsing is set (S107) with the result that the purchase price is reduced corresponding to this value (S108), and hence it follows that the user enjoys the benefit owing to the reduction in the purchase price (S109).

The information terminal 100 having completed the storage of the set information in S106 requests the server 200 to distribute an advertisement containing a contract ID 122h etc at a preset timing (S110). In the server 200, the advertisement distributee address 122r stored as a piece of set information in the storage unit 122 is utilized as a URL.

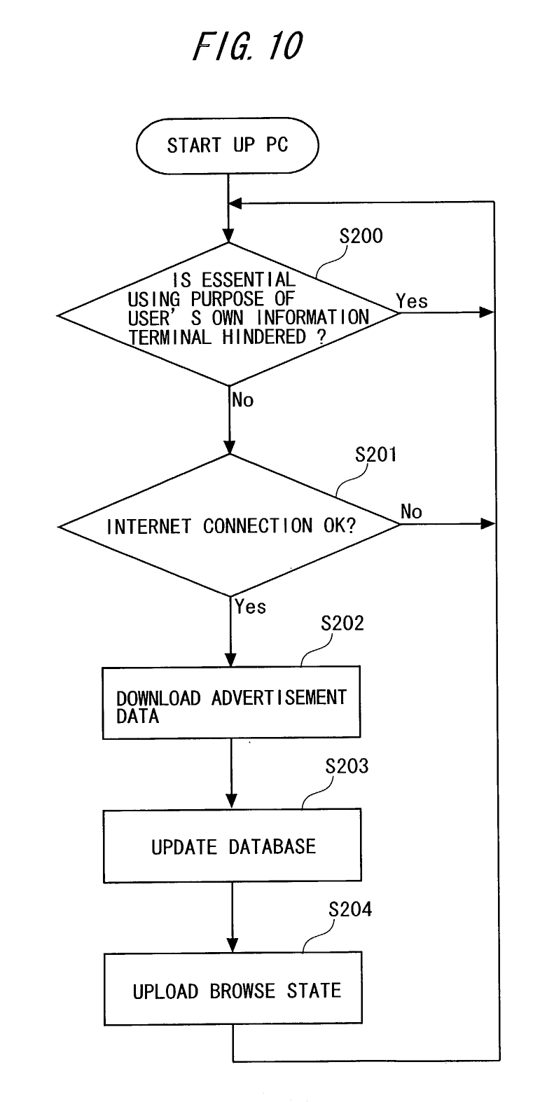

This advertisement distribution request process will be explained in depth with reference to the drawings. FIG. 10 is an explanatory flowchart showing the advertisement distribution request process.

When the information terminal 100 is started up, it is judged whether an execution of the advertisement distribution request process hinders the essential using purpose of the information terminal (S200). To be specific, it is judged whether the system (e.g., the CPU 111) is in an idle (or sleep) state. As a result, when judging that the system is in the idle state, it may be considered that the execution of the above process does not hinder the essential using purpose of the information terminal (S200: No).

Further, it may also be judged whether a communication bandwidth in the communication unit 121 is smaller than a threshold value. As a consequence, when judging that the communication bandwidth is not smaller than the threshold value, it is also to be considered that the execution of the above process does not hinder the essential using purpose of the information terminal (S200: No). Moreover, it may also be judged whether (one or a plurality of) specified applications are in the process of being executed. As a result, when judging that (one or the plurality of) specified applications are not in the process of being executed, it is to be deemed that the execution of the above process does not hinder the essential using purpose of the information terminal (S200: No).

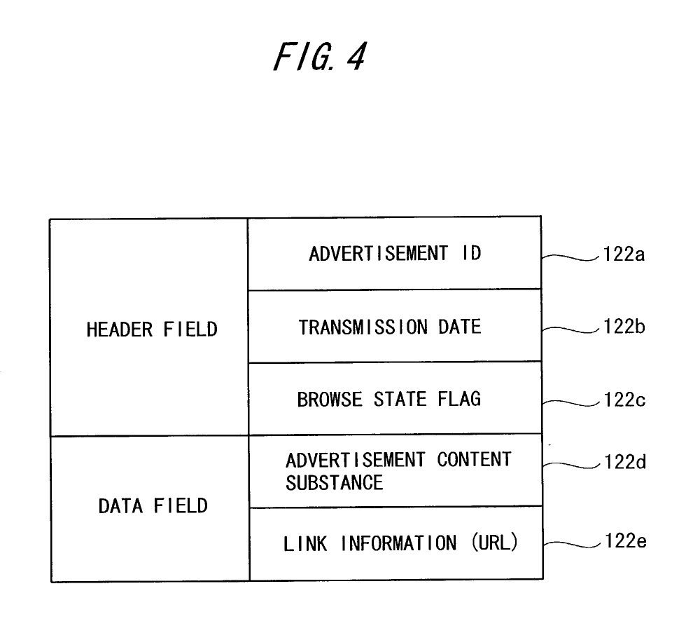

When judging in S200 that the execution of the advertisement distribution request process does not hinder the essential using purpose of the information terminal (S200: No), it is judged whether the communication unit 121 is connected to the network (S201). In the case of judging that the communication unit 121 is connected to the network (S201: Yes), the communication unit 121 requests the server 200 to distribute the advertisement containing the contract ID 122h etc, and obtains the advertisement data (see FIG. 4) from the server 200 via the network. Then, the database is updated based on the advertisement data (S203). Upon a completion of updating, the data showing a state of the browsing are uploaded to the server 200 (S204).

The server 200, when receiving the advertisement distribution request from the information terminal 110, generates the advertisement data (see FIG. 4) transmitted to the information terminal 100 on the basis of the advertisement data (see FIG. 7) stored in the storage unit 204. The server 200 transmits the generated advertisement data to the information terminal 100 from the transmitting unit 202 (the advertisement distribution process) (S111). Then, the server 200 adds the number of the transmitted advertisements to the distribution total count 204b. Note that the server 200 is provided with advertisement materials sequentially from the advertisement provider (S121). The server 200 then generates pieces of information for distribution from the advertisement materials and stored the generated information in the storage unit 204 (S122).

The information terminal 100 receives and stores the advertisement data generated in S111 in the storage unit 122 (S112). Then, the number of the advertisement contents received is added to the receipt total count 122m. Further, the number of the advertisement contents received is added to the present storage count 122p.

The user, when browsing or discarding the advertisement content substance 122d stored in the storage unit 122, inputs a browsing or discarding command by operating the sub operation unit 125 (S113).

When the browsing command is inputted through the sub operation unit 125, the advertisement content (E-advertisement) based on the advertisement content substance 122d stored in the storage unit 122 is displayed on the sub display unit 123. In this case, the browsing state flag 122c (stored in the storage unit 122) specified by the advertisement ID 122a of the displayed advertisement content, is rewritten into a piece of information indicating “already read” from the information indicating “unread”. Then, the number of the advertisement contents browsed is subtracted from the present unread count 122g (stored in the storage unit 122). Further, the number of the advertisement contents browsed is added to the browsing total count 122n (stored in the storage unit 122).

On the other hand, when the discard target advertisement content substance is designated through the sub operation unit 125 and when the discarding command is inputted, the browsing state flag 122c (stored in the storage unit 122) specified by the advertisement ID 122a of the designated advertisement content, is rewritten into a piece of information indicating “discard” from the information indicating “unread” or “already read”. Then, the number of the advertisement contents discarded is added to the discard total count 122o (stored in the storage unit 122). Further, the number of the advertisement contents discarded is subtracted from the present storage count 122p (stored in the storage unit 122).

The information terminal 100 transmits the individual data (see FIG. 5) stored in the storage unit 122 and pieces of information in a header field (see FIG. 4) together with the contract ID 122h to the server 200 at a predetermined timing (S114). Erased from the storage unit 122, upon a completion of this transmission, are the advertisement data identified by the advertisement ID of which discarding is indicated by the browsing state flag 122c and the advertisement data that become unnecessary due to the transmission in S114. A free area is thereby ensured on the storage unit 122, and the storage unit 122 can be thus effectively utilized.

The server 200 receives the individual data (see FIG. 5) and the data entered in a header field (see FIG. 4) from the information terminal 100, and updates, based on the individual data received, the individual data stored in the storage unit 204. Further, the server 200 confirms and grasps a state of how much the user implements the contract on the basis of the data received (S115). Moreover, the server 200 adds “1” to the browsing count 204c of the advertisement content substance identified by the advertisement ID of which “already read” is indicated by the browse state flag 122c contained in the header field received.

Further, the information terminal 100 confirms, based on the individual data and the advertisement data stored in the storage unit 122, whether the contract is implemented (S115). Then, the information terminal 100 repeats the processes in S110 through S116.

The server 200, just when the effective period in distributing the advertisement has elapsed, notifies the advertisement provider of he distribution state and the browse state on the basis of the data shown in FIG. 7, and charges the advertisement provider an advertisement distribution fee (S117). The advertisement provider (terminal) executes a process of paying the distribution fee to the distributor after confirming the browse state (S118). There can be considered some calculation methods by which distribution fee is calculated in a way that multiplies a predetermined upper limit amount of money by a ratio of the browsing count to the distribution count, or multiplies the browsing count by a unit price per case. With this scheme, it follows that the distributor collects the set return value (S120).

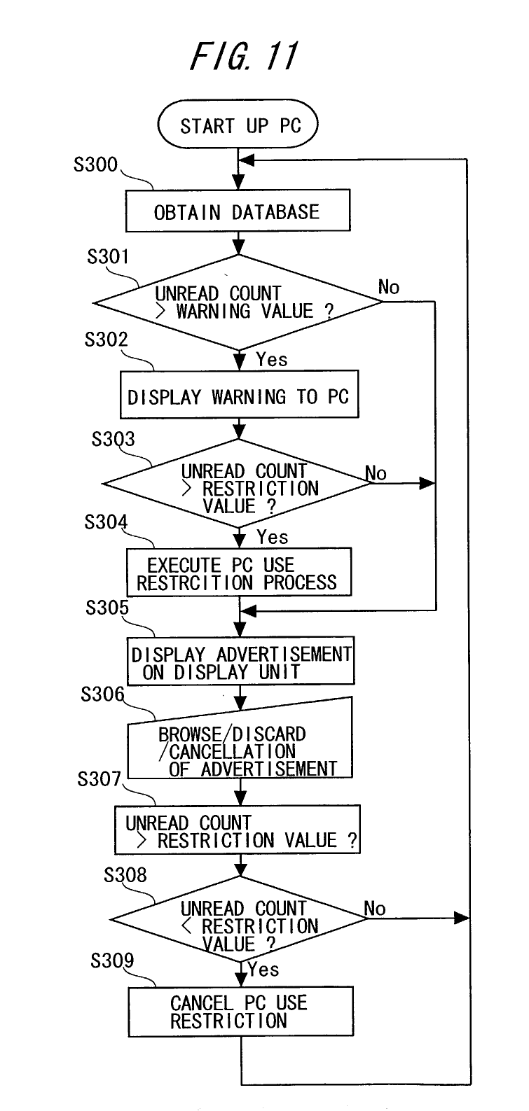

Next, an advertisement browse management process in the electronic advertisement browse promoting system having the architecture described above, will be explained with reference to the drawings. FIG. 11 is an explanatory flowchart showing the advertisement browse management process in the electronic advertisement browse promoting system.

When starting up the information terminal 100 (or only the electronic advertisement browse promoting device 120), the present unread count 122q, the warning threshold value 122k and the restriction threshold value 122l are read out of the storage unit 122 (S300). Then, it is judged whether the present unread count 122q>the warning threshold value 122k (whether the first condition is met) (S301) and whether the present unread count 122q>the restriction threshold value 122l (whether the second condition is met).

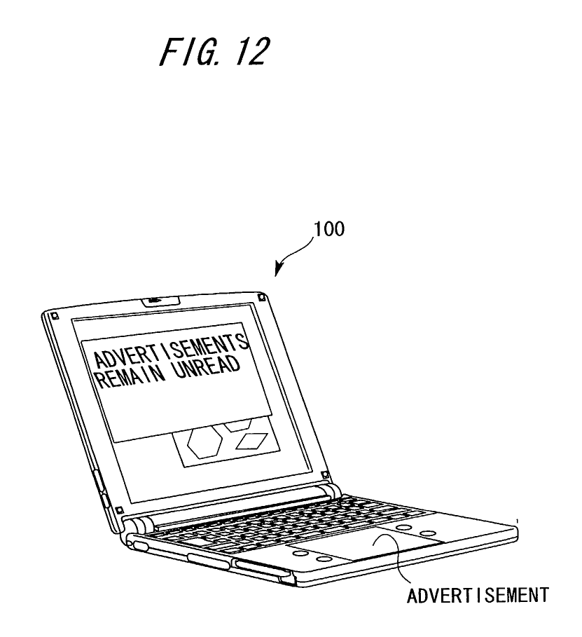

As a result, when judging that the present unread count 122q>the warning threshold value 122k (S301; Yes) (i.e., when judging that the first condition is not met), as shown in FIG. 12, an indication for prompting the user to implement the contract (the indication for prompting the user to, for instance, browse the unread E-advertisement) is displayed on the image display unit 130 (S302). This indication may be displayed on the sub display unit 123.

Further, when judging that the present unread count 122q>the restriction threshold value 122l (S303; Yes) (namely when judging that the second condition is not met), a use restriction process against the information terminal 100 is executed (S304).

The use restriction process involves controlling the computer main unit 110 not to accept operations other than the user's operations for displaying, for example, the advertisement content (E-advertisement) on the sub display unit 123 (S305 through S308). With this contrivance, it follows that the user is unable to use the computer main unit 110 for other purposes till it is judged from through browsing the unread advertisement contents that the present unread count 122q<the restriction threshold value 122l (S308).

Whereas if it is judged from browsing the unread advertisement contents that the present unread count 122q<the restriction threshold value 122l (S308: Yes), a process of canceling the use restriction in S304 is executed. For instance, this process involves controlling the computer main unit 110 to accept the operations other than the user's operation for displaying the advertisement content (E-advertisement) on the sub display unit 123 (S309) This scheme enables the user to use the computer main unit 110 for other purposes as before being restricted in S304.

Thus, if not browsing the unread advertisement content (i.e., if not following the initial contract), first of all warning is made, and next the computer main unit is controlled to be unusable for the purposes other than browsing the advertisement content. Therefore, the browsing of the advertisement can be promoted. Namely, it is possible to give the user a motivation for browsing the advertisement. Further, the entrepreneur and the advertisement provider have a merit of obtaining an improved effect against the costs for distributing the advertisement because of the distributed advertisements being browsed with not possibility of remaining unread.

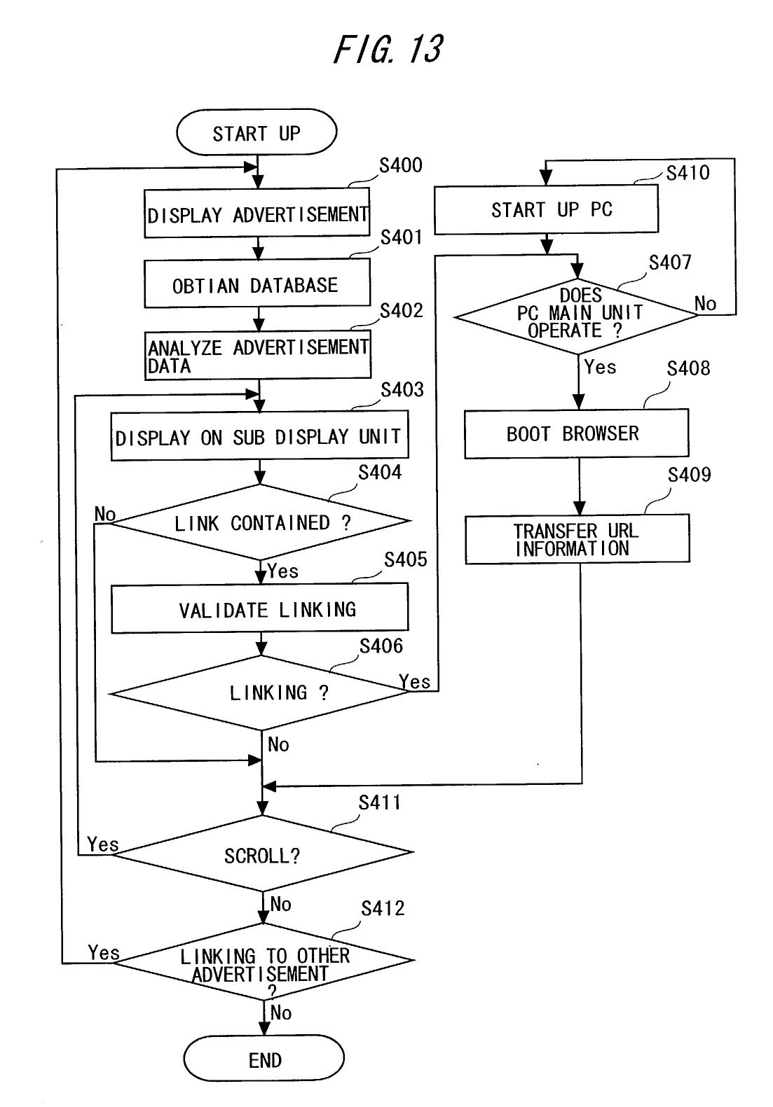

Next, an electronic advertisement display process in the electronic advertisement browse promoting system having the architecture described above, will be described with reference to the drawings. FIG. 13 is an explanatory flowchart showing the electronic advertisement display process in the electronic advertisement browse promoting system. Note that the advertisement data are stored in the storage unit 122, and hence there is no necessity for the information terminal 100 to be connected with the network on the occasion of browsing the advertisement content. Further, it is not required that all the advertisement contents stored in the storage unit 122 be browsed. The reason why unnecessary is that it is sufficient to browse just the advertisement contents of which a quantity is set up in the initial contract.

When the information terminal 100 (or only the electronic advertisement browse promoting device 120) is started up and when an advertisement display command is inputted through the sub operation unit 125 (S400) the advertisement data (see FIG. 4) are read from the storage unit 122 (S401). The readout advertisement data undergo a predetermined analysis about whether the link information 122e is contained (S402).

Then, the electronic advertisement based on the advertisement content substance 122d contained in the advertisement data, is displayed on the sub display unit 123 (S403). In the case of analyzing that the link information 122e is contained in the advertisement content being displayed on the sub display unit 123 (S404; Yes), the linking is set operable on the sub operation unit 125 (S405).

Then, when judging that the linking operation is done on the sub operation unit 125 (a linking command is inputted therefrom) (S406: Yes), it is judged whether the computer main unit 110 operates or not (S407). As a result, when judging that the computer main unit 110 operates (S407: Yes), the Browser preinstalled in the storage unit 114 is booted (S408).

Then, the link information 122e hyperlinked to the advertisement content being displayed on the sub display unit 123, is transferred to the Browser. Note that if the computer main unit 110 is judged not to operate (S407: No), the computer main unit 110 itself is automatically started up (S410), with the result that the processes in S408 and S409 are executed.

When a scroll command is inputted from on the sub operation unit 125 (S411), the processes in S403 through S409 are re-executed. Further, the electronic advertisement is displayed to the end in S403, and, when judging that there is a next electronic advertisement to be displayed (S412: Yes), the processes in S400 through S410 are again carried out.

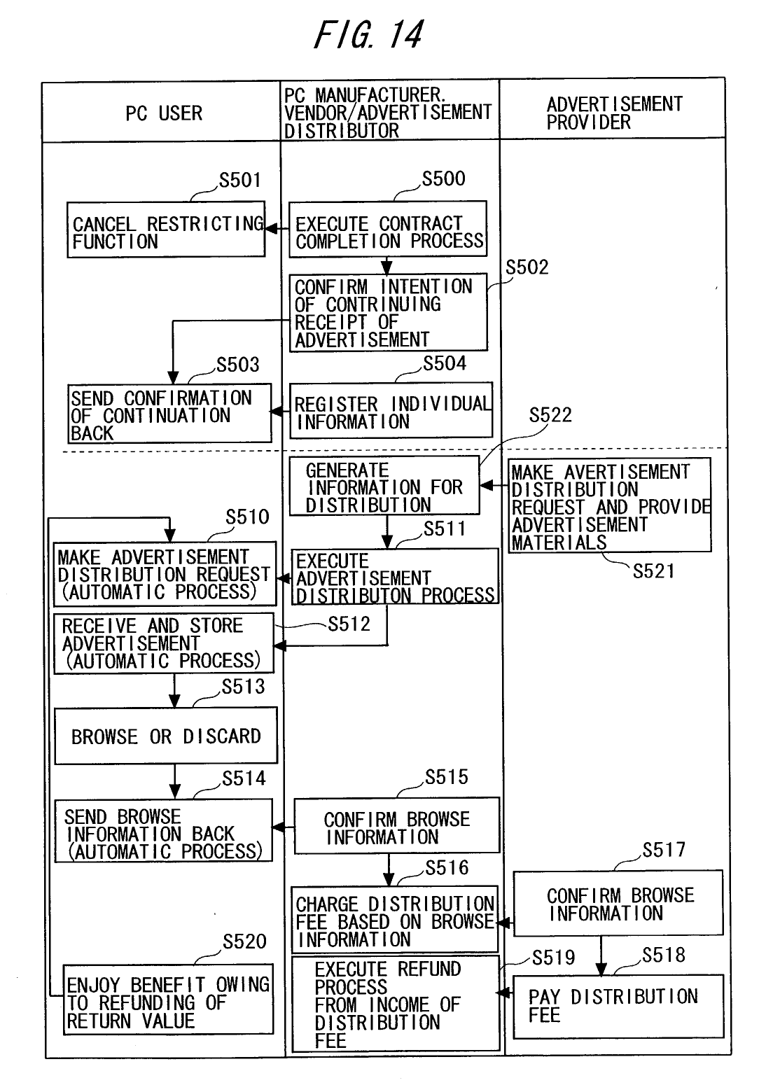

Next, an operation of the electronic advertisement browse promoting system having the architecture described above, will be explained with reference to the drawings. FIG. 14 is an explanatory flowchart showing the operation of the electronic advertisement browse promoting system.

The server 200, when judging that the contract comes to a completion, executes a contract completion process (S500). For instance, the information terminal 100 with the contract judged to be completed is notified of the completion of the contract via the network. The information terminal 100, when receiving the completion of the contract, cancels a restrictive function (S501). What can be considered is, for example, setting not to make the advertisement distribution request in S110 and setting not to control the computer main unit 110 in S300 through S309.

Further, the server 200 executes a process for confirming an intention of continuing the contract (which includes a case of modifying a part of the contract and continuing the modified contract) (S502). For example, the server 200 sends an inquiry about the continuation of the contract via the network to the information terminal 100 with the contract judged to be completed. The user sends, if the contract continues, this purport to the server 200 (S503). The server 200 registers the individual information (S504).

If the contract continues, processes in S510 through S520 are executed. These processes are substantially the same as those in S110 through S120 that have already been explained in FIG. 9, and therefore the repetitive explanations are omitted herein. Note that the advertisement distributor refunds to the user a part of the received distribution fee as a return value of browsing the advertisement and can thus motivate the user to continuously browse the advertisement and promote browsing. Moreover, what can be thought of as a refunding method may be a transfer/receipt of money, a reduction in information communication cost, a supply of coupons and so forth.

The present invention can be embodied in a variety of modes without deviating from the spirit and the principal features of the present invention. Hence, the embodiment discussed above is just a mere exemplification in every aspect of the invention but is not limitedly construed.

As discussed above, according to the present invention, it is feasible to motivate the positive browsing of the electronic advertisement. Further, owing to the reduction in the purchase price and the refund as the return value of browsing the electronic advertisement, the user of the information terminal is relieved from the monetary burden when not using the information terminal. Moreover, in the distribution of the electronic advertisement, the user is given the obligation of browsing the advertisement, and the refund as the return value of browsing the advertisement motivate the user to browse, whereby the browse of the advertisement can be promoted. Still further, the improvement of the effect against the cost for the electronic advertisement can be expected because of being charged for only the actually browsed advertisement.

What is claimed is:

1. An electronic advertisement browse promoting system for promoting browse of an electronic advertisement, comprising:
a server distributing electronic advertisement information via a network;
an acquisition unit acquiring the electronic advertisement information distributed from said server;
a storage unit storing the electronic advertisement information acquired by said acquisition unit and thereafter storing information indicating a user's response to the stored electronic advertisement information; and
a transmitting unit transmitting to a predetermined terminal the information indicating the user's response that has been stored in said storage unit.

2. An electronic advertisement browse promoting system according to claim 1, further comprising an electronic advertisement display unit displaying an electronic advertisement based on the electronic advertisement information stored in said storage unit.

3. An electronic advertisement browse promoting system according to claim 2, further comprising a computer main unit including said acquisition unit, said storage unit and said transmitting unit as built-in components.

4. An electronic advertisement browse promoting system according to claim 3, wherein said electronic advertisement display unit is built in said computer main unit.

5. An electronic advertisement browse promoting system according to claim 3, further comprising a first judging unit judging, based on the information indicating the user's response that has been storage unit and information indicating a predetermined first condition that should be kept by the user with respect to the electronic advertisement information, whether the first condition is met,
wherein if said first judging unit judges that the first condition is not met, an indication for prompting the user to meet the first condition is displayed on said electronic advertisement display unit.

6. An electronic advertisement browse promoting system according to claim 5, wherein the information indicating the user's response is information indicating a present unread count with respect to the electronic advertisement information stored in said storage unit, and
the first condition is a first total count of pieces of electronic advertisement information that should be browsed by the user within a predetermined period.

7. An electronic advertisement browse promoting system according to claim 6, further comprising:
a second judging unit judging, based on the information indicating the user's response that has been storage unit and information indicating a predetermined second condition that should be kept by the user with respect to the electronic advertisement information, whether the second condition is met; and
a control unit controlling said computer main unit if said second judging unit judges that the second condition is not met.

8. An electronic advertisement browse promoting system according to claim 7, wherein the second condition is a second total count of pieces of electronic advertisement information that should be browsed by the user with the predetermined period.

9. An electronic advertisement browse promoting system according to claim 8, wherein the second total count is set larger than the first total count.

10. An electronic advertisement browse promoting system according to claim 7, wherein said first judging unit, said second judging unit and said control unit are built in said computer main unit.

11. An electronic advertisement browse promoting system according to claim 7, wherein said first and second judging units are provided on said predetermined terminal,
said control unit is built in said computer main unit, and
said computer main unit further includes a judgement result acquisition unit acquiring results of the judgements made by said first and second judging units from on said predetermined terminal.

12. An electronic advertisement browse promoting system according to claim 7, wherein said control unit, when judging that the second condition is not met, controls said computer main unit not to accept operations other than the user's operation for displaying the electronic advertisement on said electronic advertisement display unit.

13. An electronic advertisement browse promoting system according to claim 12, wherein said control unit, when judging that the second condition is met, controls said computer main unit to accept the operations other than the user's operation for displaying the electronic advertisement on said electronic advertisement display unit.

14. An electronic advertisement browse promoting device for promoting browse of an electronic advertisement, comprising:
an acquisition unit acquiring electronic advertisement information;
a storage unit storing the electronic advertisement information acquired by said acquisition unit and thereafter storing information indicating a user's response to the stored electronic advertisement information; and
a transmitting unit transmitting to a predetermined terminal the information indicating the user's response that has been stored in said storage unit.

15. An electronic advertisement browse promoting device according to claim 14, further comprising an electronic advertisement display unit displaying an electronic advertisement based on the electronic advertisement information stored in said storage unit.

16. An electronic advertisement browse promoting device built-in type computer including a computer main unit having a built-in electronic advertisement browse promoting device for promoting browse of an electronic advertisement, comprising:
an acquisition unit acquiring the electronic advertisement information;
a storage unit storing the electronic advertisement information acquired by said acquisition unit and thereafter storing information indicating a user's response to the stored electronic advertisement information; and
a transmitting unit transmitting to a predetermined terminal the information indicating the user's response that has been stored in said storage unit.

17. An electronic advertisement browse promoting device built-in type computer according to claim 16, further comprising an electronic advertisement display unit displaying an electronic advertisement based on the electronic advertisement information stored in said storage unit.

18. An electronic advertisement browse promoting device built-in type computer according to claim 17, wherein said electronic advertisement display unit is built in said computer main unit.

19. An electronic advertisement browse promoting device built-in type computer according to claim 17, further comprising a first judging unit judging, based on the information indicating the user's response that has been storage unit and information indicating a predetermined first condition that should be kept by the user with respect to the electronic advertisement information, whether the first condition is met,
wherein if said first judging unit judges that the first condition is not met, an indication for prompting the user to meet the first condition is displayed on said electronic advertisement display unit.

20. An electronic advertisement browse promoting device built-in type computer according to claim 19, wherein the information indicating the user's response is information indicating a present unread count with respect to the electronic advertisement information stored in said storage unit, and
the first condition is a first total count of pieces of electronic advertisement information that should be browsed by the user within a predetermined period.

21. An electronic advertisement browse promoting device built-in type computer according to claim 20, further comprising:
a second judging unit judging, based on the information indicating the user's response that has been storage unit and information indicating a predetermined second condition that should be kept by the user with respect to the electronic advertisement information, whether the second condition is met; and
a control unit controlling said computer main unit if said second judging unit judges that the second condition is not met.

22. An electronic advertisement browse promoting device built-in type computer according to claim 21, wherein the second condition is a second total count of pieces of electronic advertisement information that should be browsed by the user with the predetermined period.

23. An electronic advertisement browse promoting device built-in type computer according to claim 22, wherein the second total count is set larger than the first total count.

24. An electronic advertisement browse promoting device built-in type computer according to claim 21, wherein said control unit, when judging that the second condition is not met, controls said computer main unit not to accept operations other than the user's operation for displaying the electronic advertisement on said electronic advertisement display unit.

25. An electronic advertisement browse promoting device built-in type computer according to claim 24, wherein said control unit, when judging that the second condition is met, controls said computer main unit to accept the operations other than the user's operation for displaying the electronic advertisement on said electronic advertisement display unit.

26. An electronic advertisement browse promoting method in a computer including a computer main unit having, as built-in components, an acquisition unit acquiring the electronic advertisement information, a storage unit storing the acquired electronic advertisement information and an electronic advertisement display unit displaying an electronic advertisement based on the stored electronic advertisement information, said method comprising:
storing information indicating a user's response to the stored electronic advertisement information; and
transmitting to a predetermined terminal the stored information indicating the user's response.

27. An electronic advertisement browse promoting method according to claim 26, further comprising:
judging, based on the stored information indicating the user's and information indicating a predetermined first condition that should be kept by the user with respect to the electronic advertisement information, whether the first condition is met; and
displaying, when judging that the first condition is not met, an indication for prompting the user to meet the first condition on said electronic advertisement display unit.

28. An electronic advertisement browse promoting method according to claim 27, wherein the information indicating the user's response is information indicating a present unread count with respect to the electronic advertisement information stored in said storage unit, and
the first condition is a first total count of pieces of electronic advertisement information that should be browsed by the user within a predetermined period.

29. An electronic advertisement browse promoting method according to claim 28, further comprising:
judging, based on the stored information indicating the user's and information indicating a predetermined second condition that should be kept by the user with respect to the electronic advertisement information, whether the second condition is met; and
controlling said computer main unit when judging that the second condition is not met.

30. An electronic advertisement browse promoting method according to claim 29, wherein the second condition is a second total count of pieces of electronic advertisement information that should be browsed by the user with the predetermined period.

31. An electronic advertisement browse promoting method according to claim 30, wherein the second total count is set larger than the first total count.

32. An electronic advertisement browse promoting method according to claim 29, wherein said control involves controlling said computer main unit not to accept operations other than the user's operation for displaying the electronic advertisement on said electronic advertisement display unit.

33. An electronic advertisement browse promoting method according to claim 32, wherein said control involves controlling said computer main unit to accept the operations other than the user's operation for displaying the electronic advertisement on said electronic advertisement display unit.

34. An electronic advertisement browse promoting program in a computer including a computer main unit having, as built-in components, an acquisition unit acquiring the electronic advertisement information, a storage unit storing the acquired electronic advertisement information and an electronic advertisement display unit displaying an electronic advertisement based on the stored electronic advertisement information, said program making said computer execute:
storing information indicating a user's response to the stored electronic advertisement information; and
transmitting to a predetermined terminal the stored information indicating the user's response.

35. An electronic advertisement browse promoting program according to claim 34, further making said computer execute:
judging, based on the stored information indicating the user's and information indicating a predetermined first condition that should be kept by the user with respect to the electronic advertisement information, whether the first condition is met; and
displaying, when judging that the first condition is not met, an indication for prompting the user to meet the first condition on said electronic advertisement display unit.

36. An electronic advertisement browse promoting program according to claim 35, wherein the information indicating the user's response is information indicating a present unread count with respect to the electronic advertisement information stored in said storage unit, and
the first condition is a first total count of pieces of electronic advertisement information that should be browsed by the user within a predetermined period.

37. An electronic advertisement browse promoting program according to claim 36, further making said computer execute:
judging, based on the stored information indicating the user's and information indicating a predetermined second condition that should be kept by the user with respect to the electronic advertisement information, whether the second condition is met; and
controlling said computer main unit when judging that the second condition is not met.

38. An electronic advertisement browse promoting program according to claim 37, wherein the second condition is a second total count of pieces of electronic advertisement information that should be browsed by the user with the predetermined period.

39. An electronic advertisement browse promoting program according to claim 38, wherein the second total count is set larger than the first total count.

40. An electronic advertisement browse promoting program according to claim 37, wherein said control involves controlling said computer main unit not to accept operations other than the user's operation for displaying the electronic advertisement on said electronic advertisement display unit.

41. An electronic advertisement browse promoting program according to claim 40, wherein said control involves controlling said computer main unit to accept the operations other than the user's operation for displaying the electronic advertisement on said electronic advertisement display unit.
